(19) United States
(12) Patent Application Publication
(10) Pub. No.: US 2023/0322219 A1
(43) Pub. Date: Oct. 12, 2023

(54) VEHICLE CONTROL APPARATUS

(71) Applicant: Mitsubishi Electric Corporation, Tokyo (JP)

(72) Inventor: Tomoki UNO, Tokyo (JP)

(73) Assignee: Mitsubishi Electric Corporation, Tokyo (JP)

(21) Appl. No.: 18/159,131

(22) Filed: Jan. 25, 2023

(30) Foreign Application Priority Data
Apr. 11, 2022 (JP) 2022-064904
Dec. 8, 2022 (JP) 2022-196108

(51) Int. Cl. B60W 30/14; B60W 40/072; B60W 50/00

(52) U.S. Cl. CPC B60W 30/143; B60W 40/072; B60W 50/0098; B60W 2050/0083; B60W 2520/105; B60W 2520/125; B60W 2552/30

(57) ABSTRACT

To provide a vehicle control apparatus which can control appropriately the travelling speed at traveling on the curve, considering not only the lateral acceleration at traveling on the curve but also the longitudinal acceleration. A vehicle control apparatus calculates a curve limitation travelling speed at which the lateral acceleration of the own vehicle becomes the maximum lateral acceleration or less, based on the road shape and the maximum lateral acceleration; corrects the curve limitation travelling speed so that a composite acceleration of the own vehicle at traveling on the curve road becomes within a limit range which is set according to the maximum lateral acceleration, the maximum longitudinal acceleration in the front direction, and the maximum longitudinal acceleration in the back direction; and controls the vehicle according to the curve limitation travelling speed after correction.

### INCORPORATION BY REFERENCE

The disclosure of Japanese Patent Application No. 2022-64904 filed on Apr. 11, 2022 and No. 2022-196108 filed on Dec. 8, 2022 including its specification, claims and drawings, is incorporated herein by reference in its entirety.

### BACKGROUND

This present disclosure is related with a vehicle control apparatus.

There is proposed a system which decelerates so that the lateral acceleration becomes less than or equal to a setting value, in the case where the lateral acceleration which is generated on the vehicle exceeds the setting value, according to the curve information of the front road, and the lateral acceleration at turning (for example, JP 2015-217848 A).

In JP 2015-217848 A, the system is provided with the maximum lateral acceleration acquisition unit which acquires the maximum lateral acceleration which can be generated by the vehicle, and the curve shape information acquisition unit that acquires shape information including the curvature radius of curve. And, the system sets the target acceleration in the back direction of the traveling direction of the vehicle at the start point of the curve, to an acceleration whose magnitude is equal to the maximum lateral acceleration; and sets the target acceleration in the back direction of the traveling direction of the vehicle at the curvature radius minimum point of the curve, to 0; sets the target acceleration in the back direction between the start point of the curve, and the curvature radius minimum point so as to decrease from this start point toward the curvature radius minimum point; and controls.

### SUMMARY

JP 2015-217848 A describes that the target acceleration in the back direction at the curve start point is set to the magnitude equal to the maximum lateral acceleration. However, depending on the value of the set maximum lateral acceleration, although it is suitable for traveling the curve, it may be too large or too small for the acceleration in the back direction, and the riding comfort is deteriorated.

Then, the purpose of the present disclosure is to provide a vehicle control apparatus which can control appropriately the travelling speed at traveling on the curve, considering not only the lateral acceleration at traveling on the curve but also the longitudinal acceleration.

A vehicle control apparatus according to the present disclosure, including:
a road shape acquisition unit that acquires a road shape where an own vehicle travels;
a lateral movement parameter setting unit that sets a maximum lateral acceleration which is allowable at turning;
a curve limitation speed calculation unit that calculates a curve limitation travelling speed which is a travelling speed, at traveling on a curve road, at which a lateral acceleration of the own vehicle becomes the maximum lateral acceleration or less, based on the road shape and the maximum lateral acceleration;
an acceleration parameter setting unit that sets a maximum longitudinal acceleration in a front direction and a maximum longitudinal acceleration in a back direction during traveling on the curve road;
a travelling speed correction unit that corrects the curve limitation travelling speed so that a composite acceleration of the own vehicle at traveling on the curve road becomes within a limit range which is set according to the maximum lateral acceleration, the maximum longitudinal acceleration in the front direction, and the maximum longitudinal acceleration in the back direction; and
a speed control unit that controls the own vehicle according to a curve limitation travelling speed after correction.

A vehicle control apparatus according to the present disclosure, the maximum lateral acceleration, the maximum longitudinal acceleration in the front direction, and the maximum longitudinal acceleration in the back direction are set individually; and the curve limitation travelling speed is set so that the composite acceleration becomes within the limit range which is set according to these. Accordingly, the travelling speed at traveling on the curve can be controlled appropriately, considering not only the lateral acceleration at traveling on the curve but also the longitudinal acceleration; and the riding comfort during traveling the curve road can be prevented from deteriorating.

### BRIEF DESCRIPTION OF THE DRAWINGS

FIG. 1 is a schematic block diagram of the vehicle control apparatus and the vehicle control system according to Embodiment 1;

FIG. 2 is a schematic hardware configuration diagram of the vehicle control apparatus according to Embodiment 1;

FIG. 3 is a figure for explaining the example at traveling on the curve road according to Embodiment 1;

FIG. 4 is a figure for explaining calculation of the curve limitation travelling speed based on the curvature according to Embodiment 1;

FIG. 5 is a figure for explaining calculation of the curve limitation travelling speed based on the curvature change rate according to Embodiment 1;

FIG. 6 is a flowchart for explaining processing of the travelling speed correction unit according to Embodiment 1;

FIG. 7 is a figure for explaining the limit range of the ellipse according to Embodiment 1;

FIG. 8 is a figure for explaining processing of the travelling speed correction unit according to Embodiment 2; and

FIG. 9 is a figure for explaining the calculation of the curve limitation travelling speed after correction according to Embodiment 3.

### DETAILED DESCRIPTION OF THE EMBODIMENTS

### 1. Embodiment 1

A vehicle control apparatus 50 and a vehicle control system 30 according to Embodiment 1 will be explained with reference to drawings. The vehicle control system 30 is mounted in an automatic driving vehicle.

### 1-1. Vehicle Control System 30

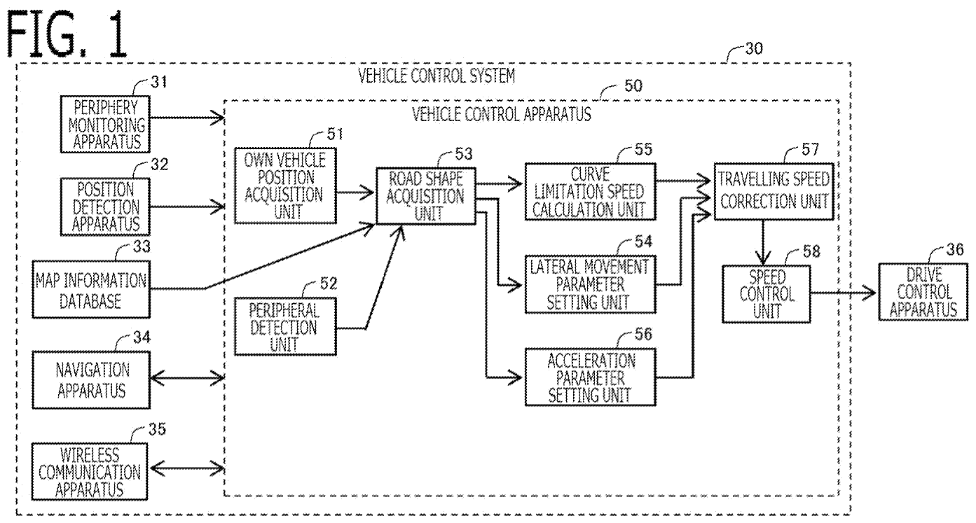

As shown in FIG. 1, the vehicle control system 30 is provided with a periphery monitoring apparatus 31, a position detection apparatus 32, a map information database 33, a navigation apparatus 34, a wireless communication apparatus 35, a drive control apparatus 36, a vehicle control apparatus 50, and the like.

The periphery monitoring apparatus 31 is an apparatus which monitors the periphery of a vehicle, such as a camera and a radar. As the radar, a millimeter wave radar, a laser radar, an ultrasonic radar, and the like are used. The position detecting apparatus 32 is an apparatus which detects the current position of the own vehicle, and a GPS antenna which receives the signal outputted from satellites, such as GNSS (Global Navigation Satellite System), is used. The wireless communication device 35 performs a wireless communication with a base station, using the wireless communication standard of cellular communication system, such as 4G and 5G.

In the map information database 33, road information, such as a road shape (position information on road, curvature, lane number, lane width), a road type, a regulation speed, a road sign, and a road signal, is stored. The map information database 33 is mainly constituted of a storage apparatus. The map information database 33 may be provided in the navigation apparatus 34, or may be provided in a server outside the vehicle connected to the network, and the navigation apparatus 34 and the vehicle control apparatus 50 may acquire required road information from the server outside the vehicle via the wireless communication apparatus 35.

The navigation apparatus 34 calculates a travel route from the present position of the own vehicle to the destination using the road information stored in the map information database 33. The destination is set by the driver, for example. The navigation apparatus 34 transmits the calculated travel route to the vehicle control apparatus 50.

As the drive control apparatus 36, a power controller, a brake controller, an automatic steering controller, a light controller, and the like are provided. The power controller controls output of power machines, such as an internal combustion engine and a motor. The brake controller controls brake operation of an electric brake apparatus. The automatic steering controller controls an electric steering apparatus. The light controller controls a direction indicator and the like.

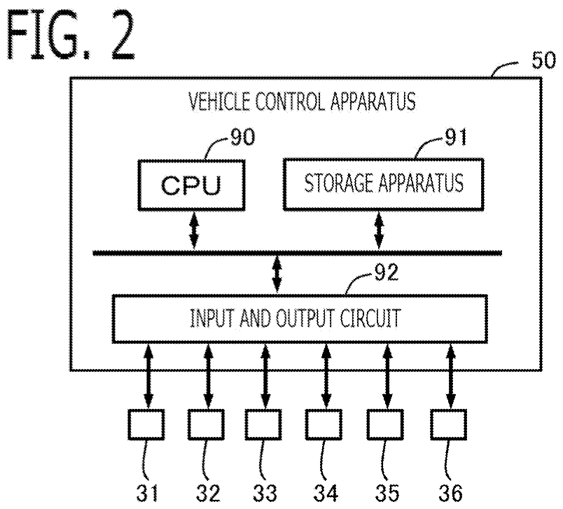

The vehicle control apparatus 50 is provided with functional units of an own vehicle position acquisition unit 51, a peripheral detection unit 52, a road shape acquisition unit 53, a lateral movement parameter setting unit 54, a curve limitation speed calculation unit 55, an acceleration parameter setting unit 56, a travelling speed correction unit 57, a speed control unit 58, and the like. Each function of the vehicle control apparatus 50 is realized by processing circuits provided in the vehicle control apparatus 50. As shown in FIG. 2, specifically, the vehicle control apparatus 50 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), a hard disk, and a DVD apparatus, are used.

The input and output circuit 92 is provided with a communication device, an A/D converter, an input/output port, a driving circuit, and the like. The input and output circuit 92 is connected to the periphery monitoring device 31, the position detecting device 32, the map information database 33, the navigation apparatus 34, the wireless communication device 35, and the drive control apparatus 36, and communicates with these devices.

Then, the arithmetic processor 90 runs software items (programs) stored in the storage apparatus 91 and collaborates with other hardware devices in the vehicle control apparatus 50, such as the storage apparatus 91, and the input and output circuit 92, so that the respective functions of the functional units 51 to 58 provided in the vehicle control apparatus 50 are realized. Setting data items, such as the maximum lateral acceleration, the maximum longitudinal acceleration, the maximum lateral jerk, and the maximum longitudinal jerk, to be utilized in the functional units 51 to 58 are stored in the storage apparatus 91, such as ROM. Each function of the vehicle control apparatus 50 will be described in detail below.

### <Own Vehicle Position Acquisition Unit 51>

The own vehicle position acquisition unit 51 acquires position information on the own vehicle. In the present embodiment, the own vehicle position acquisition unit 51 acquires the position information on the own vehicle from the position detection apparatus 32. For acquisition of the position information on the own vehicle, various kinds of methods, such as the map matching method, the dead reckoning method, the method using the traveling lane identification number of the own vehicle, and the method using the detection information around the own vehicle, may be used.

### <Peripheral Detection Unit 52>

The peripheral detection unit 52 detects condition around the own vehicle. For example, the peripheral detection unit 52 detects a road shape around the own vehicle. Specifically, the road shape acquisition unit 53 detects a shape of lane marking of road and the like, based on the detection information on a lane marking, such as a white line and a road shoulder, which is acquired from the periphery monitoring device 31; and detects a shape of driving lane, a number of driving lane, and a position of driving lane with respect to each detection object, based on the detected shape of lane marking of road and the like. For example, the lane marking of road is expressed by a plural-order polynomial (for example, third-order).

The peripheral detection unit 52 detects other vehicle, an obstacle, a pedestrian, and the like which exist around the own vehicle. The peripheral detection unit 52 detects other vehicle and the like, based on the detection information acquired from the periphery monitoring apparatus 31; and detects a position of other vehicle and the like with respect to the own vehicle.

### <Road Shape Acquisition Unit 53>

The road shape acquisition unit 53 acquires a road shape where the own vehicle travels. The acquired road shape is the road shape of a road where the own vehicle is scheduled to travel or probably travels. The road shape acquisition unit 53 acquires the road shape within a specified distance range in front of the own vehicle. The road shape acquisition unit 53 acquires a curvature ρ (L0) of each position L0 of the road in a processing range in front of the own vehicle, as the road shape. The curvature p is a reciprocal of a curvature radius and expresses a curve degree of the road. The road shape acquisition unit 53 acquires a curvature change rate dρ (L0) of each position L0 of the road in front of the own vehicle, as the road shape. The curvature ρ and the curvature change rate dρ at a predetermined position of the road in front of the own vehicle may be acquired.

For example, the road shape acquisition unit 53 acquires the road shape (the curvature ρ, curvature change rate dρ) corresponding to the travel route acquired from the navigation apparatus 34, from the map information database 33. The curvature change rate dρ may be calculated from the acquired curvature ρ. The road shape acquisition unit 53 may acquire the road shape (in this example, the polynomial of lane marking) in front of the own vehicle which is acquired by the peripheral detection unit 52. In this case, the road shape acquisition unit 53 calculates the curvature ρ of the road in front of the own vehicle, based on the polynomial of the lane marking of the road where the own vehicle travels. The road shape acquisition unit 53 calculates the curvature change rate dρ of the road in front of the own vehicle, based on the polynomial of the lane marking of the road where the own vehicle travels. For example, the curvature ρ and the curvature change rate dρ are calculated, based on a polynomial of a center line of the road calculated based on the polynomial of each lane marking.

### <Lateral Movement Parameter Setting Unit 54>

The lateral movement parameter setting unit 54 sets a maximum lateral acceleration aymax which is allowable at turning. The lateral movement parameter setting unit 54 sets a maximum lateral jerk jymax which is allowable at turning. The maximum lateral acceleration and the maximum lateral jerk are set considering a riding comfort, a commodity value, and the like. For example, the maximum lateral acceleration and the maximum lateral jerk are preliminarily set at the time of design considering a movement characteristic or a commodity value of the vehicle. The maximum lateral acceleration and the maximum lateral jerk may be adjustable by the driver. The lateral movement parameter setting unit 54 may set the maximum lateral acceleration and the maximum lateral jerk of each position, based on the road shape (for example, the curvature, the curvature change rate) of each position. The lateral movement parameter setting unit 54 may set the maximum lateral acceleration and the maximum lateral jerk, based on other parameters, such as the regulation speed and the road type.

### <Curve Limitation Speed Calculation Unit 55>

The curve limitation speed calculation unit 55 calculates a curve limitation travelling speed Vay which is a travelling speed, at traveling on the curve road, at which a lateral acceleration of the own vehicle becomes the maximum lateral acceleration aymax or less, based on the road shape and the maximum lateral acceleration aymax.

In the present embodiment, the curve limitation speed calculation unit 55 calculates the curve limitation travelling speed Vay(L0) of each processing position L0, based on the curvature ρ (L0) of each processing position L0 of the road in the processing range in front of the own vehicle, and the maximum lateral acceleration aymax. For example, the curve limitation speed calculation unit 55 calculates the curve limitation travelling speed Vay (L0) using the next equation. Herein, Vc is an upper limit value of the curve limitation travelling speed Vay which is set. And, when the road is the curve road whose curvature is greater than or equal to a specified curvature ρ corresponding to Vc, the speed control is performed using the curve limitation travelling speed Vay calculated based on the road shape and the maximum lateral acceleration. Considering the case where positive/negative of the curvature ρ of the curve road to the right side is different from positive/negative of the curvature ρ of the curve road to the left side, an absolute value of curvature |ρ| is used. Herein, min (A, B) is a function which outputs any smaller one of A and B.

$$[ Equation 1 ]$$

$${V}_{ay} ( {L}_{0} ) = min ( {V}_{c} , \sqrt{\frac{{ay}_{max}}{\vert ρ ( {L}_{0} ) \vert}} ) \qquad ( 1 )$$

Characteristics other than the equation (1) may be used. And, the curve limitation travelling speed Vay may be set to decrease, as the absolute value of the curvature ρ of the road increases; and the curve limitation travelling speed Vay may be set to increase, as the maximum lateral acceleration aymax increases.

And, in the present embodiment, the curve limitation speed calculation unit 55 calculates the curve limitation travelling speed Vref that the lateral acceleration ay of the own vehicle at traveling on the curve road becomes the maximum lateral acceleration aymax or less, and the lateral jerk jy of the own vehicle at traveling on the curve road becomes the maximum lateral jerk jymax or less, based on the road shape, the maximum lateral acceleration aymax, and the maximum lateral jerk jymax.

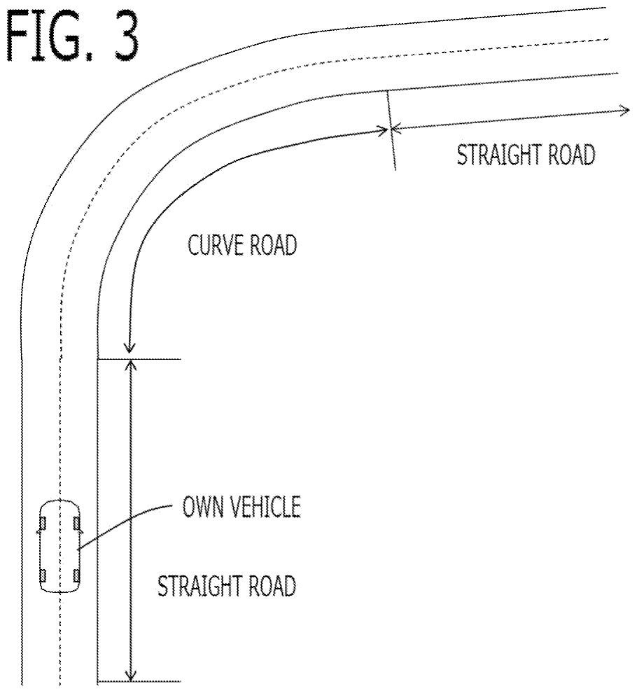

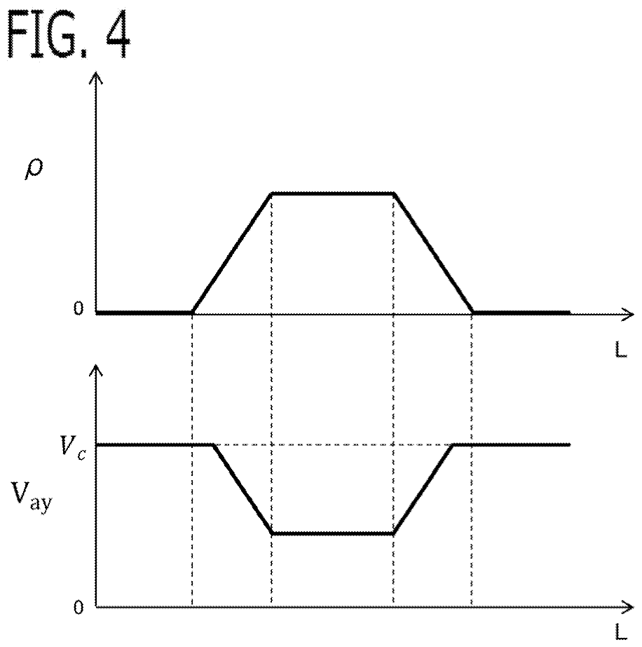

FIG. 3 and FIG. 4 shows an example of calculation of the curvature ρ (L0) and the curve limitation travelling speed Vay (L0) with respect to the front position L0 when there is the curve road in front of the own vehicle. In a range of the distance L where the curve road exists, the curvature ρ increase from 0. The curve limitation travelling speed Vay decreases according to the increase in the curvature ρ. When a value calculated based on the curvature ρ exceeds the upper limit value Vc, the upper limit value Vc is set as the curve limitation travelling speed Vay.

In the present embodiment, the curve limitation speed calculation unit 55 calculates a curve limitation travelling speed Vjy by the curvature change rate, based on the curvature change rate dρ of the road, and the maximum lateral jerk jymax. For example, using the next equation, the curve limitation speed calculation unit 55 calculates the curve limitation travelling speed Vjy by the maximum lateral jerk. An absolute value |dρ| of the curvature change rate is used considering the case where positive/negative of the curvature change rate dρ is different.

$$[ Equation 2 ]$$

$${V}_{jy} ( {L}_{0} ) = min ( {V}_{c} , \sqrt[3]{\frac{{jy}_{max}}{\vert d ρ ( {L}_{0} ) \vert}} ) \qquad ( 2 )$$

Characteristics other than the equation (2) may be used. And, the curve limitation travelling speed Vjy by the maximum lateral jerk may be set to decrease, as the absolute value of curvature change rate dρ of the road increases; and the curve limitation travelling speed Vjy by the maximum lateral jerk may be set to increase, as the maximum lateral acceleration aymax increases.

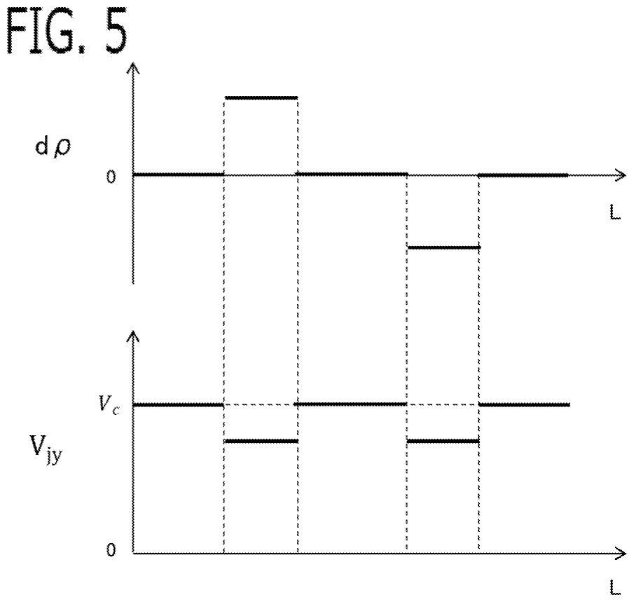

FIG. 5 shows an example of calculation of the curve limitation travelling speed Vjy (L0) by the curvature change rate dρ (L0) and the maximum lateral jerk with respect to the front position L0 when there is the same curve road as FIG. 3 in front of the own vehicle. The curvature ρ increase or decrease in the curve road, and in the section where the curvature change rate dρ becomes larger or smaller than 0, the curve limitation travelling speed Vjy decrease according to the increase in the absolute value |dρ| of the curvature change rate. When a value calculated based on the curvature change rate dρ exceeds the upper limit value Vc, the upper limit value Vc is set as the curve limitation travelling speed Vjy.

As shown in the next equation, the curve limitation speed calculation unit 55 sets either smaller one of the curve limitation travelling speed Vay by the maximum lateral acceleration, and the curve limitation travelling speed Vjy by the maximum lateral jerk, as the curve limitation travelling speed Vref.

[Equation 3]

V_{ref}(L₀)=min(V_{ay}(L₀),V_{jy}(L₀)) (3)

The curve limitation speed calculation unit 55 may set the curve limitation travelling speed Vref using one of the curve limitation travelling speed Vay by the maximum lateral acceleration, and the curve limitation travelling speed Vjy by the maximum lateral jerk.

### <Acceleration Parameter Setting Unit 56>

The acceleration parameter setting unit 56 sets a maximum longitudinal acceleration in the front direction axmaxF and a maximum longitudinal acceleration in the back direction axmaxB during traveling the curve road. Herein, the longitudinal acceleration in the front direction is an acceleration which makes the longitudinal speed increase, and the longitudinal acceleration in the back direction is an acceleration which makes the longitudinal speed decrease.

The acceleration parameter setting unit 56 sets a maximum longitudinal jerk in the front direction jmaxF and a maximum longitudinal jerk in the back direction jmaxB during traveling the curve road. Herein, the longitudinal jerk in the front direction is a jerk (jerk) which makes the longitudinal acceleration increase to the front direction, the longitudinal jerk in the back direction is a jerk (jerk) which makes the longitudinal acceleration increase to the back direction.

In the present disclosure, “lateral” is a lateral of the right and left direction on the basis of the own vehicle or the lane, and “longitudinal” is a longitudinal of the traveling direction on the basis of the own vehicle or the lane.

The maximum longitudinal accelerations in the front direction and the back direction, and the maximum longitudinal jerks in the front direction and the back direction are set considering the riding comfort, the commodity value, and the like. For example, each maximum longitudinal acceleration and each maximum longitudinal jerk are preliminarily set at the time of design, considering the movement characteristic or the commodity value of the vehicle. Each maximum longitudinal acceleration and each maximum longitudinal jerk may be adjustable by the driver. The acceleration parameter setting unit 56 may set each maximum longitudinal acceleration and each maximum longitudinal jerk, based on the road shape (slope and the like) of each position. The acceleration parameter setting unit 56 may set each maximum longitudinal acceleration and each maximum longitudinal jerk, based on other parameters, such as the regulation speed and the road type.

### <Travelling Speed Correction Unit 57>

The travelling speed correction unit 57 corrects the curve limitation travelling speed Vref so that a composite acceleration acmp of the own vehicle at traveling on the curve road becomes within a limit range which is set according to the maximum lateral acceleration aymax, the maximum longitudinal acceleration in the front direction axmaxF, and the maximum longitudinal acceleration in the back direction axmaxB.

In the present embodiment, the travelling speed correction unit 57 corrects the curve limitation travelling speed Vref so that the composite acceleration acmp falls within a limit range of an ellipse described below.

The travelling speed correction unit 57 corrects the curve limitation travelling speed Vref so that a longitudinal jerk of the own vehicle which is generated when traveling at the curve limitation travelling speed Vref becomes within a range of the maximum longitudinal jerk in the front direction jmaxF and the maximum longitudinal jerk in the back direction jmaxB.

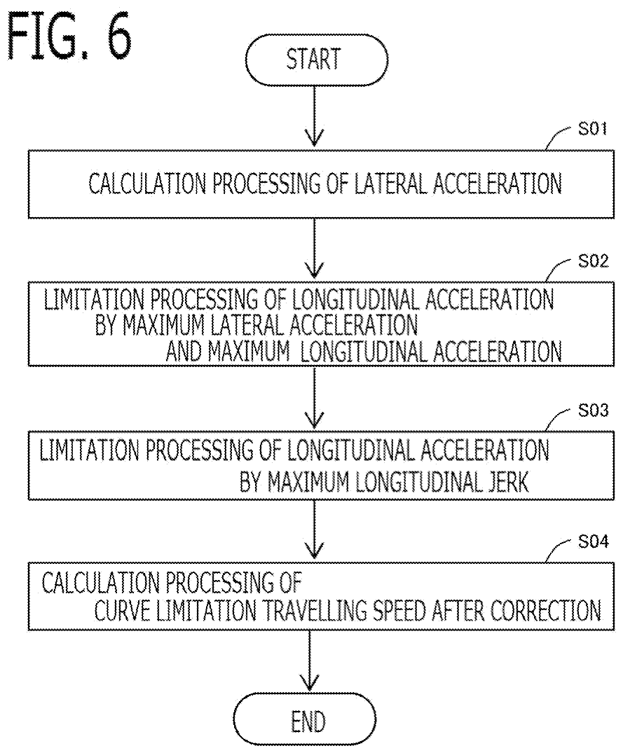

Hereinafter, processing of the travelling speed correction unit 57 will be explained using the flowchart of FIG. 6. About each processing position L0 of the road in the processing range in front of the own vehicle, processing of the flowchart of FIG. 6 is executed, and the curve limitation travelling speed Vref (L0) of each processing position L0 is corrected. The processing position L0 is increased the interval dL by the interval dL from the side closer to the own vehicle, toward the front, and is set in order.

### <Limitation of Lateral Acceleration>

In the step S01, the travelling speed correction unit 57 calculates the lateral acceleration before correction ayo when traveling at the curve limitation travelling speed Vref (hereinafter, referred to as a curve limitation travelling speed before correction Vref) calculated by the curve limitation speed calculation unit 55. In the present embodiment, the travelling speed correction unit 57 calculates the lateral acceleration before correction ayo (L0) of this time processing position L0, based on the curvature ρ (L0) of the road of this time processing position L0, and the curve limitation travelling speed before correction Vref (L0) of this time processing position L0; and calculates a lateral acceleration after correction arc (L0) by upper-limiting the absolute value of the calculated lateral acceleration before correction ayo (L0) by the maximum lateral acceleration aymax. For example, using the first equation of the next equation, the travelling speed correction unit 57 calculates the lateral acceleration before correction ayo (L0) of this time processing position L0; and using the second equation, calculates the lateral acceleration after correction ayc (L0) by limiting the calculated lateral acceleration before correction ayo (L0) within a range from −aymax to aymax. max (A, B) is a function which outputs any larger one of A and B.

[Equation 4]

ayₒ(L₀)=ρ(L₀)V_{ref}²(L₀)

ay_{c}(L₀)=min(max(ayₒ(L₀),−ayₘₐₓ),ayₘₐₓ) (4)

### <Limitation of Longitudinal Acceleration>

In the step S02, the travelling speed correction unit 57 calculates the longitudinal acceleration after correction axc (L0) that the composite acceleration acmp of the own vehicle becomes within the limit range which is set according to the maximum lateral acceleration aymax, the maximum longitudinal acceleration in the front direction axmaxF, and the maximum longitudinal acceleration in the back direction axmaxB, on a condition using the lateral acceleration after correction ayc (L0) of this time processing position L0.

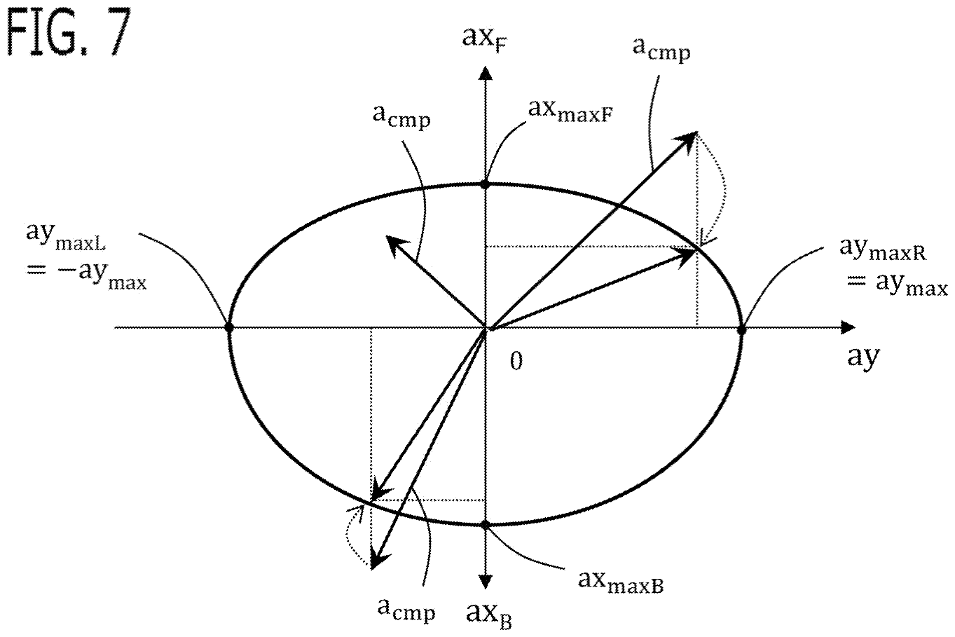

In the present embodiment, as shown in FIG. 7 and the next equation, the limit range is set to a limit range of an ellipse which passes through the maximum lateral acceleration in the left direction aymaxL, the maximum lateral acceleration in the right direction aymaxR, the maximum longitudinal acceleration in the front direction axmaxF, and the maximum longitudinal acceleration in the back direction axmaxB, in a coordinate system consisting of an axis of the lateral acceleration ay, and an axis of the longitudinal acceleration ax.

Herein, the lateral acceleration in the right direction ayR is defined as a positive value, and the lateral acceleration in the left direction ayL is defined as a negative value. The maximum lateral acceleration in the right direction aymaxR is set to the maximum lateral acceleration aymax, and the maximum lateral acceleration in the left direction aymaxL is set to −1×the maximum lateral acceleration aymax. The longitudinal acceleration in the front direction axF and the longitudinal acceleration in the back direction axB are set individually. Physically, if the longitudinal acceleration in the front direction axF is a positive longitudinal acceleration, the longitudinal acceleration in the back direction axB becomes a negative longitudinal acceleration. However, in the present embodiment, the longitudinal acceleration in the front direction axF is defined as a positive value, and the longitudinal acceleration in the back direction axB is defined as a positive value.

In the range of the longitudinal acceleration in the front direction axF, the ellipse of the limit range becomes the next equation.

$$[ Equation 5 ]$$

$${( \frac{{ax}_{F}}{{ax}_{maxF}} )}^{2} + {( \frac{ay}{{ay}_{max}} )}^{2} = 1 \qquad ( 5 )$$

In the range of the longitudinal acceleration in the back direction axB, the ellipse of the limit range becomes the next equation.

$$[ Equation 6 ]$$

$${( \frac{{ax}_{B}}{{ax}_{maxB}} )}^{2} + {( \frac{ay}{{ay}_{max}} )}^{2} = 1 \qquad ( 6 )$$

The travelling speed correction unit 57 calculates the longitudinal acceleration after correction axo (L0) that the composite acceleration acmp of the own vehicle becomes within the limit range of the ellipse of the equation (5) and the equation (6), on a condition using the lateral acceleration after correction ayc (L0).

The travelling speed correction unit 57 calculates a longitudinal acceleration before correction axo (L0) corresponding to the curve limitation travelling speed before correction Vref (L0) of this time processing position L0. As shown in the next equation, the travelling speed correction unit 57 calculates the longitudinal acceleration before correction axo (L0) by a differential operation, based on a time change amount of the curve limitation travelling speed before correction Vref (L0) of this time processing position L0. Herein, Vref (L0−dL) is the curve limitation travelling speed before correction Vref of the last time processing position (L0−dL) which is closer to the own vehicle by the interval dL than this time processing position L0. AT is a time interval corresponding to the interval dL between the last time processing position (L0−dL) and this time processing position L0; and is calculated by dividing the interval dL by the curve limitation travelling speed Vref (L0−dL) of the last time processing position (L0−dL), in this example.

$$[ Equation 7 ]$$

$${ax}_{o} ( {L}_{0} ) = \frac{{dV}_{ref} ( {L}_{0} )}{dt} = \frac{{V}_{ref} ( {L}_{0} ) - {V}_{ref} ( {L}_{0} - dL )}{Δ T} \\ Δ T = \frac{dL}{{V}_{ref} ( {L}_{0} - dL )} \qquad ( 7 )$$

In the case where the longitudinal acceleration before correction axo (L0) calculated by the equation (7) is a positive longitudinal acceleration, that is, it is within the range of the longitudinal acceleration in the front direction axF, using the next equation, the travelling speed correction unit 57 calculates a longitudinal acceleration in the front direction after correction axcF (L0) of this time processing position L0 that becomes within the limit range of the ellipse of the equation (5), based on the maximum longitudinal acceleration in the front direction axmaxF, the lateral acceleration after correction ayc (L0) of this time processing position L0, and the maximum lateral acceleration aymax.

$$[ Equation 8 ]$$

$$IN THE CASE OF {a}_{o} ( {L}_{0} ) \geq 0 , {ax}_{oF} ( {L}_{0} ) = {ax}_{o} ( {L}_{0} ) \\ 1 ) WHEN {ax}_{oF} ( {L}_{0} ) > {ax}_{maxF} \sqrt{1 - {( \frac{{ay}_{c} ( {L}_{0} )}{{ay}_{max}} )}^{2}} , \\ {ax}_{cF} ( {L}_{0} ) = {ax}_{maxF} \sqrt{1 - {( \frac{{ay}_{c} ( {L}_{0} )}{{ay}_{max}} )}^{2}} \\ 2 ) WHEN {ax}_{oF} ( {L}_{0} ) \leq {ax}_{maxF} \sqrt{1 - {( \frac{{ay}_{c} ( {L}_{0} )}{{ay}_{max}} )}^{2}} , \\ {ax}_{cF} ( {L}_{0} ) = {ax}_{oF} ( {L}_{0} ) \qquad ( 8 )$$

In the case where the longitudinal acceleration before correction axo (L0) corresponding to the curve limitation travelling speed before correction Vref (L0) of this time processing position L0 is a negative longitudinal acceleration, that is, it is within the range of the longitudinal acceleration in the back direction axB, using the next equation, the travelling speed correction unit 57 calculates a longitudinal acceleration in the back direction after correction axcB (L0) of this time processing position L0 that becomes within the limit range of the ellipse of the equation (6), based on the maximum longitudinal acceleration in the back direction axmaxB, the lateral acceleration after correction ayc (L0) of this time processing position L0, and the maximum lateral acceleration aymax.

$$[ Equation 9 ]$$

$$IN THE CASE OF {ax}_{o} ( {L}_{0} ) < 0 , {ax}_{oB} ( {L}_{0} ) = \vert {ax}_{o} ( {L}_{0} ) \vert \\ 1 ) WHEN {ax}_{oB} ( {L}_{0} ) > {ax}_{maxB} \sqrt{1 - {( \frac{{ay}_{c} ( {L}_{0} )}{{ay}_{max}} )}^{2}} , \\ {ax}_{cB} ( {L}_{0} ) = {ax}_{maxB} \sqrt{1 - {( \frac{{ay}_{c} ( {L}_{0} )}{{ay}_{max}} )}^{2}} \\ 2 ) WHEN {ax}_{oB} ( {L}_{0} ) \leq {ax}_{maxB} \sqrt{1 - {( \frac{{ay}_{c} ( {L}_{0} )}{{ay}_{max}} )}^{2}} , \\ {ax}_{cB} ( {L}_{0} ) = {ax}_{oB} ( {L}_{0} ) \qquad ( 9 )$$

As shown in FIG. 7, the composite acceleration is corrected so that the composite acceleration acmp falls within the limit range of the ellipse. As seen from FIG. 7, when the lateral acceleration after correction ayc (absolute value) is small, the longitudinal acceleration after correction in the front direction or the back direction axcF, axcB become comparatively large. When the lateral acceleration after correction ayc (absolute value) is large, the longitudinal acceleration after correction in the front direction or the back direction axcF, axcB become comparatively small.

### <Limitation of Longitudinal Jerk>

In the step S03, the travelling speed correction unit 57 corrects the longitudinal acceleration in the front direction or the back direction axcF (L0), axcB (L0) so that the longitudinal jerk which is generated by the longitudinal acceleration in the front direction or the back direction after correction axcF (L0), axcB (L0) by the acceleration of this time processing position L0 becomes within the range of the maximum longitudinal jerk in the front direction jmaxF and the maximum longitudinal jerk in the back direction jmaxB.

In the case where the longitudinal acceleration before correction axo (L0) is a positive longitudinal acceleration, that is, it is within the range of the longitudinal acceleration in the front direction axF, using the next equation, the travelling speed correction unit 57 corrects the longitudinal acceleration in the front direction after correction axcF (L0) so that the longitudinal acceleration in the front direction after correction axcF (L0) by acceleration becomes the maximum longitudinal jerk in the front direction jmaxF or less. Herein, axcF (L0−dL) is the longitudinal acceleration in the front direction after correction of the last time processing position (L0−dL) which is closer to the own vehicle by the interval dL than this time processing position L0. AT is a time interval corresponding to the interval dL between the last time processing position (L0−dL) and this time processing position L0; and is calculated by dividing the interval dL by the curve limitation travelling speed Vref (L0−dL) of the last time processing position (L0−dL), in this example.

$$[ Equation 10 ]$$

$$IN THE CASE OF {ax}_{o} ( {L}_{0} ) \geq 0 , \\ {ax}_{cF} ( {L}_{0} ) = min ( {ax}_{cF} ( {L}_{0} ) , {ax}_{cF} ( {L}_{0} - dL ) + {j}_{maxF} \cdot Δ T ) \\ Δ T = \frac{dL}{{V}_{ref} ( {L}_{0} - dL )} \qquad ( 10 )$$

In the case where the longitudinal acceleration before correction axo (L0) is a negative longitudinal acceleration, that is, it is within the range of the longitudinal acceleration in the back direction axB, using the next equation, the travelling speed correction unit 57 corrects the longitudinal acceleration in the back direction after correction axcB (L0) so that the longitudinal acceleration in the back direction after correction axcB (L0) by acceleration becomes the maximum longitudinal jerk in the back direction jmaxB or less. Herein, axcB (L0−dL) is the longitudinal acceleration in the back direction after correction of the last time processing position (L0−dL) which is closer to the own vehicle by the interval dL than this time processing position L0.

$$[ Equation 11 ]$$

$$IN THE CASE OF {ax}_{o} ( {L}_{0} ) < 0 , \\ {ax}_{cB} ( {L}_{0} ) = min ( {ax}_{cB} ( {L}_{0} ) , {ax}_{cB} ( {L}_{0} - dL ) + {j}_{maxB} \cdot Δ T ) \\ Δ T = \frac{dL}{{V}_{ref} ( {L}_{0} - dL )} \qquad ( 11 )$$

<Calculation of Curve Limitation Travelling Speed after Correction>

In the step S04, the travelling speed correction unit 57 calculates the curve limitation travelling speed after correction Vrefc (L0), based on the longitudinal acceleration in the front direction or the back direction after correction axcF (L0), axcB (L0) of this time processing position L0.

In the case where the longitudinal acceleration before correction axo (L0) is a positive longitudinal acceleration, that is, it is within the range of the longitudinal acceleration in the front direction axF, using the next equation, the travelling speed correction unit 57 calculates the curve limitation travelling speed after correction Vrefc (L0), based on the longitudinal acceleration in the front direction after correction axcF (L0), and the curve limitation travelling speed after correction Vrefc of the last time processing position (L0−dL) which is closer to the own vehicle by the interval dL than this time processing position L0.

[Equation 12]

IN THE CASE OF axₒ(L₀)≥0,

V_{refc}(L₀)=min(V_{ref}(L₀),\sqrt{V_{refc}²(Lₒ−dL)+2·ax_{cF}(L₀)·dL}) (12)

In the case where the longitudinal acceleration before correction axo (L0) is a negative longitudinal acceleration, that is, it is within the range of the longitudinal acceleration in the back direction axB, using the next equation, the travelling speed correction unit 57 calculates the curve limitation travelling speed after correction Vrefc (L0), based on the longitudinal acceleration in the back direction after correction axcB (L0), and the curve limitation travelling speed after correction Vrefc of the last time processing position (L0−dL) which is closer to the own vehicle by the interval dL than this time processing position L0. Since it decelerates, it is subtracted by 2×axcB(L0)×dL.

[Equation 13]

IN THE CASE OF axₒ(L₀)<0,

(V_{refc}(L₀)=min(V_{ref}(L₀),\sqrt{V_{refc}²(Lₒ−dL)−2·ax_{cB}(L₀)·dL}) (13)

### <Speed Control Unit 58>

The speed control unit 58 controls the vehicle according to the curve limitation travelling speed after correction Vrefc. In the present embodiment, the speed control unit 58 calculates a target acceleration for traveling at a target traveling speed, and outputs it to the power controller and the brake controller of the drive control apparatus 36. During traveling at an initial target traveling speed which is set by the driver or the automatic driving function, when the curve limitation travelling speed after correction Vrefc is inputted, the speed control unit 58 upper-limits the initial target traveling speed by the curve limitation travelling speed after correction Vrefc. Specifically, when the initial target traveling speed exceeds the curve limitation travelling speed after correction Vrefc, the speed control unit 58 sets the curve limitation travelling speed after correction Vrefc as the initial target traveling speed.

According to the above configuration of the present embodiment, the maximum lateral acceleration aymax, the maximum longitudinal acceleration in the front direction axmaxF, and the maximum longitudinal acceleration in the back direction axmaxB are set individually; and the curve limitation travelling speed is set so that the composite acceleration becomes within the limit range which is set according to these. Accordingly, the riding comfort during traveling the curve road can be prevented from deteriorating. Furthermore, the curve limitation travelling speed is set so as to become within the range of the maximum longitudinal jerk in the front direction jmaxF and the maximum longitudinal jerk in the back direction jmaxB. Accordingly, the riding comfort can be prevented from deteriorating.

### 2. Embodiment 2

Next, the vehicle control apparatus 50 and the vehicle control system 30 according to Embodiment 2 will be explained. The explanation for constituent parts the same as those in Embodiment 1 will be omitted. The basic configuration of the vehicle control apparatus 50 and the vehicle control system 30 according to the present embodiment is the same as that of Embodiment 1. A part of processing of the travelling speed correction unit 57 is different from Embodiment 1.

### <At Longitudinal Acceleration in Front Direction>

In the present embodiment, the lateral movement parameter setting unit 54 sets a bound lateral acceleration aylimF, at the longitudinal acceleration in the front direction, which is smaller than the maximum lateral acceleration aymax.

When the longitudinal acceleration ax which is generated when traveling at the curve limitation travelling speed becomes a value (a positive value) of the front direction, and the absolute value of the lateral acceleration ay which is generated when traveling at the curve limitation travelling speed becomes within a range from the bound lateral acceleration aylimF at the longitudinal acceleration in the front direction to the maximum lateral acceleration aymax, the travelling speed correction unit 57 corrects the curve limitation travelling speed Vref so that the longitudinal acceleration ax becomes 0.

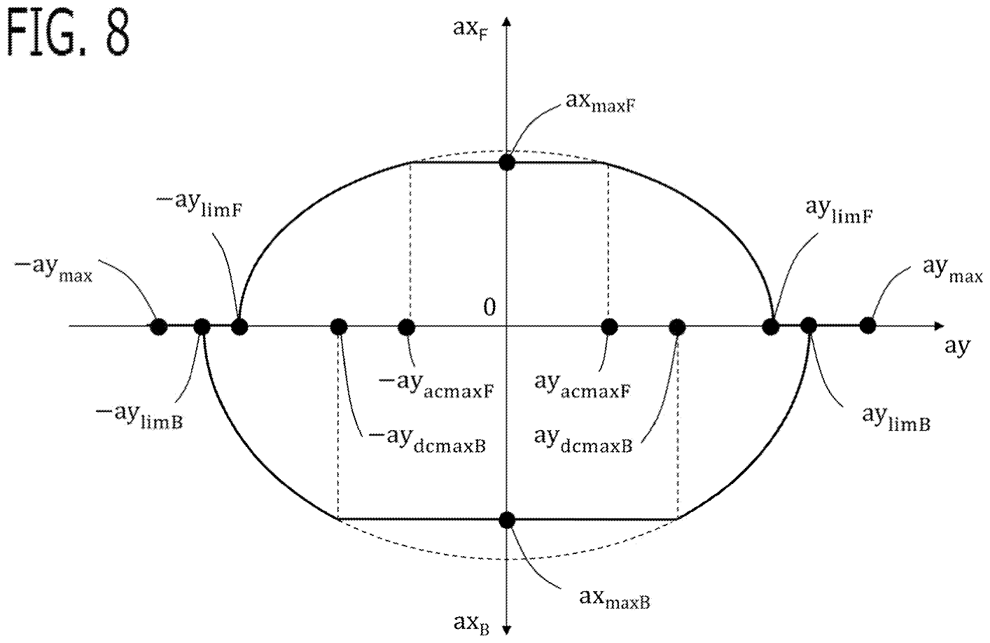

In the present embodiment, in the coordinate system consisting of the axis of the lateral acceleration ay and the axis of the longitudinal acceleration ax which are shown in FIG. 8 and the next equation, when the composite acceleration acmp becomes out of the range of the ellipse which passes through the bound lateral acceleration aylimF in the left direction and the right direction at the longitudinal acceleration in the front direction, and the maximum longitudinal acceleration in the front direction axmaxF, the travelling speed correction unit 57 limits the longitudinal acceleration in the front direction after correction axcF (L0) within the range of this ellipse.

$$[ Equation 14 ]$$

$${( \frac{{ax}_{F}}{{ax}_{maxF}} )}^{2} + {( \frac{ay}{{ay}_{limF}} )}^{2} = 1 \qquad ( 14 )$$

In the case where the longitudinal acceleration before correction axo (L0) calculated by the equation (7) is a positive longitudinal acceleration, that is, it is within the range of the longitudinal acceleration in the front direction axF, using the next equation, based on the bound lateral acceleration aylimF at the longitudinal acceleration in the front direction, the maximum longitudinal acceleration in the front direction axmaxF, and the lateral acceleration after correction ayc (L0) of this time processing position L0, when the longitudinal acceleration in the front direction after correction axcF (L0) of this time processing position L0 becomes out of the range of the ellipse of the equation (13), the travelling speed correction unit 57 limits the longitudinal acceleration in the front direction after correction axcF (L0) of this time processing position L0 within the range of this ellipse.

$$[ Equation 15 ]$$

$$IN THE CASE OF {ax}_{o} ( {L}_{0} ) \geq 0 \\ 1 ) WHEN {ax}_{cF} ( {L}_{0} ) > {ax}_{maxF} \sqrt{1 - {( \frac{{ay}_{c} ( {L}_{0} )}{{ay}_{limF}} )}^{2}} , \\ {ax}_{cF} ( {L}_{0} ) = {ax}_{maxF} \sqrt{1 - {( \frac{{ay}_{c} ( {L}_{0} )}{{ay}_{limF}} )}^{2}} \\ 2 ) WHEN {ax}_{cF} ( {L}_{0} ) \leq {ax}_{maxF} \sqrt{1 - {( \frac{{ay}_{c} ( {L}_{0} )}{{ay}_{limF}} )}^{2}} , \\ {ax}_{cF} ( {L}_{0} ) = {ax}_{cF} ( {L}_{0} ) \qquad ( 15 )$$

According to this configuration, when traveling at the lateral acceleration which is smaller than the bound lateral acceleration aylimF at the longitudinal acceleration in the front direction, it can accelerate without limitation in the front direction.

In the present embodiment, the lateral movement parameter setting unit 54 sets the maximum acceleration lateral acceleration ayacmaxF, at the longitudinal acceleration in the front direction, which is smaller than the maximum lateral acceleration aymax.

When the longitudinal acceleration ax which is generated when traveling at the curve limitation travelling speed becomes a value (a positive value) of the front direction, and the absolute value of the lateral acceleration ay which is generated when traveling at the curve limitation travelling speed becomes the maximum acceleration lateral acceleration ayacmaxF or less, the travelling speed correction unit 57 corrects the curve limitation travelling speed Vref so that the longitudinal acceleration ax becomes the maximum longitudinal acceleration in the front direction axmaxF. Using the next equation, the travelling speed correction unit 57 sets the longitudinal acceleration in the front direction after correction axcF (L0) of this time processing position L0.

$$[ Equation 16 ]$$

$$1 ) WHEN \vert {ay}_{o} ( {L}_{0} ) \vert \leq {ay}_{acmaxF} , \\ {ax}_{cF} ( {L}_{0} ) = min ( {ax}_{maxF} , \frac{{ax}_{maxF}}{\sqrt{1 - {( \frac{{ay}_{acmaxF}}{{ay}_{max}} )}^{2}}} \cdot \sqrt{1 - {( \frac{{ay}_{c} ( {L}_{0} )}{{ay}_{max}} )}^{2}} ) \qquad ( 16 )$$

According to this configuration, when traveling at the lateral acceleration less than or equal to the maximum acceleration lateral acceleration ayacmaxF, it can accelerate at the maximum longitudinal acceleration in the front direction axmaxF.

But, in the equation (16), the bound lateral acceleration aylimF at the longitudinal acceleration in the front direction is not considered. If the bound lateral acceleration aylimF at the longitudinal acceleration in the front direction is set, the next equation is used. The maximum acceleration lateral acceleration ayacmaxF is set to a value smaller than the bound lateral acceleration aylimF at the longitudinal acceleration in the front direction.

$$[ Equation 17 ]$$

$$1 ) WHEN \vert {ay}_{c} ( {L}_{0} ) \vert \leq {ay}_{acmaxF} , \\ {ax}_{cF} ( {L}_{0} ) = min ( {ax}_{maxF} , \frac{{ax}_{maxF}}{\sqrt{1 - {( \frac{{ay}_{acmaxF}}{{ay}_{limF}} )}^{2}}} \cdot \sqrt{1 - {( \frac{{ay}_{c} ( {L}_{0} )}{{ay}_{limF}} )}^{2}} ) \qquad ( 17 )$$

### <At Longitudinal Acceleration in Back Direction>

The lateral movement parameter setting unit 54 sets the bound lateral acceleration aylimB, at the longitudinal acceleration in the back direction, which is smaller than the maximum lateral acceleration aymax.

When the longitudinal acceleration ax which is generated when traveling at the curve limitation travelling speed becomes a value (a negative value) of the back direction, and the absolute value of the lateral acceleration ay when traveling at the curve limitation travelling speed becomes within a range from the bound lateral acceleration aylimB at the longitudinal acceleration in the back direction to the maximum lateral acceleration aymax, the travelling speed correction unit 57 corrects the curve limitation travelling speed Vref so that the longitudinal acceleration ax becomes 0.

In the present embodiment, in the coordinate system consisting of the axis of the lateral acceleration ay and the axis of the longitudinal acceleration ax which are shown in FIG. 8 and the next equation, when the composite acceleration acmp becomes out of the range of the ellipse which passes through the bound lateral acceleration aylimB in the left direction and the right direction at the longitudinal acceleration in the back direction, and the maximum longitudinal acceleration in the back direction axmaxB, the travelling speed correction unit 57 limits the longitudinal acceleration in the back direction after correction axcB (L0) within the range of this ellipse.

$$[ Equation 18 ]$$

$${( \frac{{ax}_{B}}{{ax}_{maxB}} )}^{2} + {( \frac{ay}{{ay}_{limB}} )}^{2} = 1 \qquad ( 18 )$$

In the case where the longitudinal acceleration before correction axo (L0) calculated by the equation (7) is a negative longitudinal acceleration, that is, it is within the range of the longitudinal acceleration in the back direction axB, using the next equation, based on the bound lateral acceleration aylimB at the longitudinal acceleration in the back direction, the maximum longitudinal acceleration in the back direction axmaxB, and the lateral acceleration after correction ayc (L0) of this time processing position L0, when the longitudinal acceleration in the back direction after correction axcB (L0) of this time processing position L0 becomes out of the range of the ellipse of the equation (18), the travelling speed correction unit 57 limits the longitudinal acceleration in the back direction after correction axcB (L0) of this time processing position L0 within the range of this ellipse.

$$[ Equation 19 ]$$

$$IN THE CASE OF {ax}_{o} ( {L}_{0} ) < 0 \\ 1 ) WHEN {ax}_{cB} ( {L}_{0} ) > {ax}_{maxB} \sqrt{1 - {( \frac{{ay}_{c} ( {L}_{0} )}{{ay}_{limB}} )}^{2}} , \\ {ax}_{cB} ( {L}_{0} ) = {ax}_{maxB} \sqrt{1 - {( \frac{{ay}_{c} ( {L}_{0} )}{{ay}_{limB}} )}^{2}} \\ 2 ) WHEN {ax}_{cB} ( {L}_{0} ) \leq {ax}_{maxB} \sqrt{1 - {( \frac{{ay}_{c} ( {L}_{0} )}{{ay}_{limB}} )}^{2}} , \\ {ax}_{cB} ( {L}_{0} ) = {ax}_{cB} ( {L}_{0} ) \qquad ( 19 )$$

According to this configuration, when traveling at the lateral acceleration which is smaller than the bound lateral acceleration aylimB at the longitudinal acceleration in the back direction, it can decelerate without limitation in the back direction.

In the present embodiment, the lateral movement parameter setting unit 54 sets the maximum deceleration lateral acceleration aydcmaxB, at the longitudinal acceleration in the back direction, which is smaller than the maximum lateral acceleration aymax.

When the longitudinal acceleration ax which is generated when traveling at the curve limitation travelling speed becomes a value (a negative value) of the back direction, and the absolute value of the lateral acceleration ay which is generated when traveling at the curve limitation travelling speed becomes the maximum deceleration lateral acceleration aydcmaxB or less, the travelling speed correction unit 57 corrects the curve limitation travelling speed Vref so that the longitudinal acceleration ax becomes the maximum longitudinal acceleration in the back direction axmaxB. Using the next equation, the travelling speed correction unit 57 sets the longitudinal acceleration in the back direction after correction axcB (L0) of this time processing position L0.

$$[ Equation 20 ]$$

$$1 ) WHEN \vert {ay}_{c} ( {L}_{0} ) \vert \leq {ay}_{dcmaxB} \\ {ax}_{cB} ( {L}_{0} ) = min ( {ax}_{maxB} , \frac{{ax}_{maxB}}{\sqrt{1 - {( \frac{{ay}_{dcmaxB}}{{ay}_{max}} )}^{2}}} \cdot \sqrt{1 - {( \frac{{ay}_{c} ( {L}_{0} )}{{ay}_{max}} )}^{2}} ) \qquad ( 20 )$$

According to this configuration, when traveling at the lateral acceleration less than or equal to the maximum deceleration lateral acceleration aydcmaxB, it can decelerate at the maximum longitudinal acceleration in the back direction axmaxB.

But, in the equation (20), the bound lateral acceleration aylimB at the longitudinal acceleration in the back direction is not considered. If the bound lateral acceleration aylimB at the longitudinal acceleration in the back direction is set, the next equation is used. The maximum deceleration lateral acceleration aydcmaxB is set to a value smaller than the bound lateral acceleration aylimB at the longitudinal acceleration in the back direction.

$$[ Equation 21 ]$$

$$1 ) WHEN \vert {ay}_{c} ( {L}_{0} ) \vert \leq {ay}_{acmaxB} , \\ {ax}_{cB} ( {L}_{0} ) = min ( {ax}_{maxB} , \frac{{ax}_{maxB}}{\sqrt{1 - {( \frac{{ay}_{dcmaxB}}{{ay}_{limB}} )}^{2}}} \cdot \sqrt{1 - {( \frac{{ay}_{c} ( {L}_{0} )}{{ay}_{limB}} )}^{2}} ) \qquad ( 21 )$$

According to the configuration of the present embodiment, in addition to the maximum lateral acceleration aymax, the maximum longitudinal acceleration in the front direction axmaxF, and the maximum longitudinal acceleration in the back direction axmaxB of Embodiment 1, by setting the bound lateral acceleration aylimF at the longitudinal acceleration in the front direction, the maximum acceleration lateral acceleration ayacmaxF, the bound lateral acceleration aylimB at the longitudinal acceleration in the back direction, and the maximum deceleration lateral acceleration aydcmaxB, the curve limitation travelling speed Vref suitable for the feeling of driver can be calculated. The riding comfort can be further prevented from deteriorating.

In each of the above-mentioned embodiments, the limit range of the ellipse which passes through the maximum lateral acceleration aymax, the maximum longitudinal acceleration in the front direction axmaxF, and the maximum longitudinal acceleration in the back direction axmaxB was set. However, the limit range of an arbitrary shape (for example, a rectangle, a curve) which passes through the maximum lateral acceleration aymax, the maximum longitudinal acceleration in the front direction axmaxF, and the maximum longitudinal acceleration in the back direction axmaxB may be set. An arbitrary shape which passes through the bound lateral acceleration aylimF at the longitudinal acceleration in the front direction, and the maximum longitudinal acceleration in the front direction axmaxF may be set. An arbitrary shape which passes through the bound lateral acceleration aylimB at the longitudinal acceleration in the back direction, and the maximum longitudinal acceleration in the back direction axmaxB may be set.

### 3. Embodiment 3

Next, the vehicle control apparatus 50 and the vehicle control system 30 according to Embodiment 3 will be explained. The explanation for constituent parts the same as those in Embodiment 1 will be omitted. The basic configuration of the vehicle control apparatus 50 and the vehicle control system 30 according to the present embodiment is the same as that of Embodiment 1 or 2. A part of processing of the travelling speed correction unit 57 is different from Embodiment 1.

The travelling speed correction unit 57 calculates the curve limitation travelling speed after correction Vrefc (L0), based on the longitudinal acceleration in the front direction or the back direction after correction axcF (L0), axcB (L0) of this time processing position L0.

In the present embodiment, unlike Embodiment 1, the calculating method of the curve limitation travelling speed after correction Vrefc (L0) is different according to whether it is the acceleration section, the deceleration section, or the constant speed section of the curve limitation travelling speed before correction Vref. The acceleration section is set to a section where the longitudinal acceleration before correction axo (L0) is a positive value. The constant speed section is set to a section where the longitudinal acceleration before correction axo (L0) is 0. The deceleration section is set to a section where the longitudinal acceleration before correction axo (L0) is a negative value.

In the acceleration section and the constant speed section in front of the acceleration section, of the curve limitation travelling speed before correction Vref, the travelling speed correction unit 57 calculates the curve limitation travelling speed after correction Vrefc in order toward front so that the composite acceleration acmp becomes within the limit range. In the present embodiment, in the acceleration section and the constant speed section in front of the acceleration section, using the next equation similar to the equation (12), the travelling speed correction unit 57 calculates, as the curve limitation travelling speed after correction Vrefc (L0) of this time processing position L0, a speed of this time processing position L0 when accelerating at the longitudinal acceleration in the front direction after correction axcF (L0) of this time processing position L0 from the curve limitation travelling speed after correction Vrefc (L0−dL) of the last time processing position (L0-dL) which is closer (back side) to the own vehicle by the interval dL than this time processing position L0. The processing position L0 is moved toward front the interval dL by the interval dL, and calculation of the equation (22) is executed repeatedly. The curve limitation travelling speed after correction Vrefc is upper-limited so as not to exceed the curve limitation travelling speed before correction Vref (L0) of this time processing position. The curve limitation travelling speed after correction Vrefc of the starting position of the acceleration section is set to the curve limitation travelling speed before correction Vref.

[Equation 22]

IN THE CASE OF THE ACCELERATION SECTION AND THE CONSTANT SPEED SECTION IN FRONT OF THE ACCELERATION SECTION,

V_{refc}(L₀)=min(V_{ref}(L₀),\sqrt{V_{refc}²(Lₒ−dL)+2·ax_{cF}(L₀)·dL}) (22)

On the other hand, in the deceleration section and the constant speed section in back of the deceleration section, of the curve limitation travelling speed before correction Vref, the travelling speed correction unit 57 calculates the curve limitation travelling speed after correction Vrefc in order toward back so that the composite acceleration acmp becomes within the limit range. In the present embodiment, in the deceleration section and the constant speed section in back of the deceleration section, using the equation (13) which is different from the next equation, the travelling speed correction unit 57 calculates, as the curve limitation travelling speed after correction Vrefc (L0) of this time processing position L0, a speed of this time processing position L0 that a speed of a position forward from this time processing position L0 by the interval dL becomes the curve limitation travelling speed after correction Vrefc (L0+dL) of the last time processing position (L0+dL) which is forward by the interval dL, when decelerating from this time processing position L0 at the longitudinal acceleration in the back direction after correction axcB (L0) of this time processing position L0. Herein, the longitudinal acceleration in the back direction after correction axcB becomes a positive value. The processing position L0 is moved back the interval dL by the interval dL, and calculation of the equation (23) is executed repeatedly. The curve limitation travelling speed after correction Vrefc is upper-limited so as not to exceed the curve limitation travelling speed before correction Vref (L0) of this time processing position. The curve limitation travelling speed after correction Vrefc of the end position of the deceleration section is set to the curve limitation travelling speed before correction Vref.

[Equation 23]

IN THE CASE OF THE DECELERATION SECTION AND THE CONSTANT SPEED SECTION IN BACK OF THE DECELERATION SECTION,

V_{refc}(L₀)=min(V_{ref}(L₀),\sqrt{V_{refc}²(Lₒ+dL)+2·ax_{cB}(L₀)·dL}) (23)

In the case where the constant speed section is the constant speed section in front of the acceleration section and is the constant speed section in back of the deceleration section, the travelling speed correction unit 57 calculates either smaller one of the curve limitation travelling speed after correction Vrefc calculated in order toward front by the equation (22), and the curve limitation travelling speed after correction Vrefc calculated in order toward back by the equation (23), as the final curve limitation travelling speed after correction Vrefc.

In the case where the constant speed section is not the constant speed section in front of the acceleration section and is not the constant speed section in back of the deceleration section, the travelling speed correction unit 57 calculates the curve limitation travelling speed before correction Vref, as the curve limitation travelling speed after correction Vrefc.

<Example of Calculation of Curve Limitation Travelling Speed after Correction Vrefc>

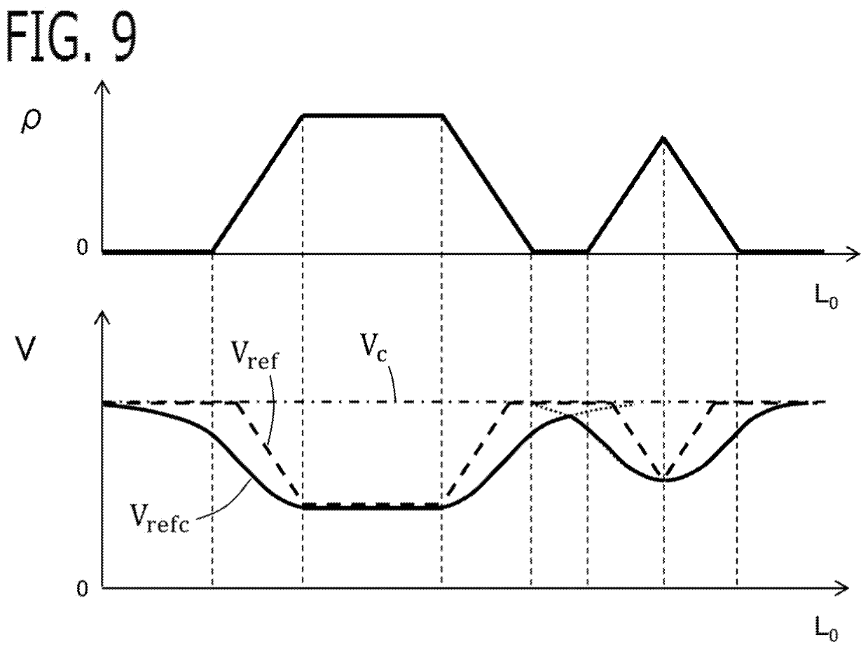

An example of calculation of the curve limitation travelling speed after correction Vrefc will be explained using FIG. 9. FIG. 9 shows the example of calculation of the curvature ρ (L0), each acceleration, and each speed with respect to each front processing position L0 when there is the curve road in front of the own vehicle. In a range of the distance L where the curve road exists, the curvature ρ increase from 0. According to the increase in the curvature ρ, the curve limitation travelling speed before correction Vref decreases from the upper limit value Vc, and the acceleration section and the deceleration section occur. The constant speed section occurs before and after the acceleration section or the deceleration section.

When the absolute value of the curvature ρ is 0, the curve limitation travelling speed before correction Vref is upper-limited by the upper limit value Vc, and coincides with the upper limit value Vc. According to the increase amount of the absolute value of the curvature ρ, the curve limitation travelling speed before correction Vref decreases from the upper limit value Vc.

The curve limitation travelling speed after correction Vrefc is corrected to decrease from the curve limitation travelling speed before correction Vref, around the deceleration section and the acceleration section of the curve limitation travelling speed before correction Vref so that the lateral acceleration and the longitudinal acceleration of the own vehicle become within the limit range. As explained using the equation (23), in the deceleration section and the constant speed section in back of the deceleration section, the curve limitation travelling speed after correction Vrefc of the end position of the deceleration section is set to the curve limitation travelling speed before correction Vref, the curve limitation travelling speed after correction Vrefc is calculated in order toward back from the end position of the deceleration section, and is corrected to decrease from the curve limitation travelling speed before correction Vref. As shown in FIG. 9, in the deceleration section and the constant speed section in back of the deceleration section, since the curve limitation travelling speed after correction Vrefc is calculated in order toward back, while keeping the lateral acceleration and the longitudinal acceleration of the own vehicle within the limit range, the curve limitation travelling speed after correction Vrefc which becomes less than or equal to the upper limit value Vc according to the curvature ρ can be calculated

As explained using the equation (22), in the acceleration section and the constant speed section in front of the acceleration section, the curve limitation travelling speed after correction Vrefc of the starting position of the acceleration section is set to the curve limitation travelling speed before correction Vref, the curve limitation travelling speed after correction Vrefc is calculated in order toward front from the starting position of the acceleration section, and is corrected to decrease from the curve limitation travelling speed before correction Vref. As shown in FIG. 9, in the acceleration section and the constant speed section in front of the acceleration section, since the curve limitation travelling speed after correction Vrefc is calculated in order toward front, while keeping the lateral acceleration and the longitudinal acceleration of the own vehicle within the limit range, the curve limitation travelling speed after correction Vrefc which becomes less than or equal to the upper limit value Vc according to the curvature ρ can be calculated.

On the other hand, in the case where the constant speed section is the constant speed section in front of the acceleration section and is the constant speed section in back of the deceleration section, either smaller one of the curve limitation travelling speed after correction Vrefc calculated in order toward front by the equation (22), and the curve limitation travelling speed after correction Vrefc calculated in order toward back by the equation (23) is set to the final curve limitation travelling speed after correction Vrefc. Accordingly, in the constant speed section, considering influence of both of the acceleration section and the deceleration section of front and back, while keeping the lateral acceleration and the longitudinal acceleration of the own vehicle within the limit range, the curve limitation travelling speed after correction Vrefc which becomes less than or equal to the upper limit value Vc according to the curvature ρ can be calculated.

In the case where the constant speed section is not the constant speed section in front of the acceleration section and is not the constant speed section in back of the deceleration section, the curve limitation travelling speed before correction Vref is calculating as the curve limitation travelling speed after correction Vrefc.

### <Summary of Aspects of Present Disclosure>

Hereinafter, the aspects of the present disclosure is summarized as appendices.

### APPENDIX 1

A vehicle control apparatus comprising:
a road shape acquisition unit that acquires a road shape where an own vehicle travels;
a lateral movement parameter setting unit that sets a maximum lateral acceleration which is allowable at turning;
a curve limitation speed calculation unit that calculates a curve limitation travelling speed which is a travelling speed, at traveling on a curve road, at which a lateral acceleration of the own vehicle becomes the maximum lateral acceleration or less, based on the road shape and the maximum lateral acceleration;
an acceleration parameter setting unit that sets a maximum longitudinal acceleration in a front direction and a maximum longitudinal acceleration in a back direction during traveling on the curve road;
a travelling speed correction unit that corrects the curve limitation travelling speed so that a composite acceleration of the own vehicle at traveling on the curve road becomes within a limit range which is set according to the maximum lateral acceleration, the maximum longitudinal acceleration in the front direction, and the maximum longitudinal acceleration in the back direction; and
a speed control unit that controls the own vehicle according to a curve limitation travelling speed after correction.

### APPENDIX 2

The vehicle control apparatus according to appendix 1,
wherein the lateral movement parameter setting unit sets a maximum lateral jerk which is allowable at turning, and
wherein the curve limitation speed calculation unit calculates the curve limitation travelling speed that the lateral acceleration of the own vehicle at traveling on the curve road becomes the maximum lateral acceleration or less, and a lateral jerk of the own vehicle at traveling on the curve road becomes the maximum lateral jerk or less, based on the road shape, the maximum lateral acceleration, and the maximum lateral jerk.

### APPENDIX 3

The vehicle control apparatus according to appendix 1 or 2,
wherein the acceleration parameter setting unit sets a maximum longitudinal jerk in the front direction and a maximum longitudinal jerk in the back direction during traveling the curve road, and
wherein the travelling speed correction unit corrects the curve limitation travelling speed so that a longitudinal jerk of the own vehicle which is generated when traveling at the curve limitation travelling speed becomes within a range of the maximum longitudinal jerk in the front direction and the maximum longitudinal jerk in the back direction.

### APPENDIX 4

The vehicle control apparatus according to any one of appendices 1 to 3,
wherein the travelling speed correction unit corrects the curve limitation travelling speed so that the composite acceleration falls within a limit range of an ellipse which passes through the maximum lateral acceleration in a left direction, the maximum lateral acceleration in a right direction, the maximum longitudinal acceleration in the front direction, and the maximum longitudinal acceleration in the back direction, in a coordinate system consisting of an axis of lateral acceleration and an axis of longitudinal acceleration.

### APPENDIX 5

The vehicle control apparatus according to any one of appendices 1 to 4,
wherein the lateral movement parameter setting unit sets a bound lateral acceleration, at the longitudinal acceleration in the front direction, which is smaller than the maximum lateral acceleration; and
wherein, when the longitudinal acceleration which is generated when traveling at the curve limitation travelling speed becomes a value of the front direction, and the lateral acceleration which is generated when traveling at the curve limitation travelling speed becomes within a range from the bound lateral acceleration at the longitudinal acceleration in the front direction to the maximum lateral acceleration, the travelling speed correction unit corrects the curve limitation travelling speed so that the longitudinal acceleration becomes 0.

### APPENDIX 6

The vehicle control apparatus according to any one of appendices 1 to 5,
wherein the lateral movement parameter setting unit sets a bound lateral acceleration, at the longitudinal acceleration in the back direction, which is smaller than the maximum lateral acceleration,
wherein, the longitudinal acceleration which is generated when traveling at the curve limitation travelling speed becomes a value of the back direction, and the lateral acceleration which is generated when traveling at the curve limitation travelling speed becomes within a range from the bound lateral acceleration at the longitudinal acceleration in the back direction to the maximum lateral acceleration, the travelling speed correction unit corrects the curve limitation travelling speed so that the longitudinal acceleration becomes 0.

### APPENDIX 7

The vehicle control apparatus according to any one of appendices 1 to 4,
wherein the lateral movement parameter setting unit sets a maximum acceleration lateral acceleration, at the longitudinal acceleration in the front direction, which is smaller than the maximum lateral acceleration,
wherein, when the longitudinal acceleration which is generated when traveling at the curve limitation travelling speed becomes a value of the front direction, and the lateral acceleration which is generated when traveling at the curve limitation travelling speed becomes the maximum acceleration lateral acceleration at the longitudinal acceleration in the front direction or less, the travelling speed correction unit corrects the curve limitation travelling speed so that the longitudinal acceleration becomes the maximum longitudinal acceleration in the front direction.

### APPENDIX 8

The vehicle control apparatus according to any one of appendices 1 to 4, and 7,
wherein the lateral movement parameter setting unit sets a maximum deceleration lateral acceleration, at the longitudinal acceleration in the back direction, which is smaller than the maximum lateral acceleration,
wherein, when the longitudinal acceleration which is generated when traveling at the curve limitation travelling speed becomes a value of the back direction, and the lateral acceleration which is generated when traveling at the curve limitation travelling speed becomes the maximum deceleration lateral acceleration at the longitudinal acceleration in the back direction or less, the travelling speed correction unit corrects the curve limitation travelling speed so that the longitudinal acceleration becomes the maximum longitudinal acceleration in the back direction.

### APPENDIX 9

The vehicle control apparatus according to any one of appendices 1 to 8,
wherein, in an acceleration section of the curve limitation travelling speed, and a constant speed section in front of the acceleration section, the travelling speed correction unit calculates the curve limitation travelling speed after correction in order toward front so that the composite acceleration becomes within the limit range;
in a deceleration section of the curve limitation travelling speed, and the constant speed section in back of the deceleration section, the travelling speed correction unit calculates the curve limitation travelling speed after correction in order toward back so that the composite acceleration becomes within the limit range;
in a case where the constant speed section of the curve limitation travelling speed is the constant speed section in front of the acceleration section and is the constant speed section in back of the deceleration section, the travelling speed correction unit calculates either smaller one of the curve limitation travelling speed after correction calculated in order toward front, and the curve limitation travelling speed after correction calculated in order toward back, as the final curve limitation travelling speed after correction; and
in a case where the constant speed section of the curve limitation travelling speed is not the constant speed section in front of the acceleration section and is not the constant speed section in back of the deceleration section, the travelling speed correction unit calculates the curve limitation travelling speed, as the curve limitation travelling speed after correction.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle control apparatus comprising at least one processor configured to implement:
a road shape acquisitor that acquires a road shape where an own vehicle travels;
a lateral movement parameter setter that sets a maximum lateral acceleration which is allowable at turning;
a curve limitation speed calculator that calculates a curve limitation travelling speed which is a travelling speed, at traveling on a curve road, at which a lateral acceleration of the own vehicle becomes the maximum lateral acceleration or less, based on the road shape and the maximum lateral acceleration;
an acceleration parameter setter that sets a maximum longitudinal acceleration in a front direction and a maximum longitudinal acceleration in a back direction during traveling on the curve road;
a travelling speed corrector that corrects the curve limitation travelling speed so that a composite acceleration of the own vehicle at traveling on the curve road becomes within a limit range which is set according to the maximum lateral acceleration, the maximum longitudinal acceleration in the front direction, and the maximum longitudinal acceleration in the back direction; and
a speed controller that controls the own vehicle according to a curve limitation travelling speed after correction.

2. The vehicle control apparatus according to claim 1,
wherein the lateral movement parameter setter sets a maximum lateral jerk which is allowable at turning, and
wherein the curve limitation speed calculator calculates the curve limitation travelling speed that the lateral acceleration of the own vehicle at traveling on the curve road becomes the maximum lateral acceleration or less, and a lateral jerk of the own vehicle at traveling on the curve road becomes the maximum lateral jerk or less, based on the road shape, the maximum lateral acceleration, and the maximum lateral jerk.

3. The vehicle control apparatus according to claim 1,
wherein the acceleration parameter setter sets a maximum longitudinal jerk in the front direction and a maximum longitudinal jerk in the back direction during traveling the curve road, and
wherein the travelling speed corrector corrects the curve limitation travelling speed so that a longitudinal jerk of the own vehicle which is generated when traveling at the curve limitation travelling speed becomes within a range of the maximum longitudinal jerk in the front direction and the maximum longitudinal jerk in the back direction.

4. The vehicle control apparatus according to claim 1,
wherein the travelling speed corrector corrects the curve limitation travelling speed so that the composite acceleration falls within a limit range of an ellipse which passes through the maximum lateral acceleration in a left direction, the maximum lateral acceleration in a right direction, the maximum longitudinal acceleration in the front direction, and the maximum longitudinal acceleration in the back direction, in a coordinate system consisting of an axis of lateral acceleration and an axis of longitudinal acceleration.

5. The vehicle control apparatus according to claim 1,
wherein the lateral movement parameter setter sets a bound lateral acceleration, at the longitudinal acceleration in the front direction, which is smaller than the maximum lateral acceleration; and
wherein, when the longitudinal acceleration which is generated when traveling at the curve limitation travelling speed becomes a value of the front direction, and the lateral acceleration which is generated when traveling at the curve limitation travelling speed becomes within a range from the bound lateral acceleration at the longitudinal acceleration in the front direction to the maximum lateral acceleration, the travelling speed corrector corrects the curve limitation travelling speed so that the longitudinal acceleration becomes 0.

6. The vehicle control apparatus according to claim 1,
wherein the lateral movement parameter setter sets a bound lateral acceleration, at the longitudinal acceleration in the back direction, which is smaller than the maximum lateral acceleration,
wherein, the longitudinal acceleration which is generated when traveling at the curve limitation travelling speed becomes a value of the back direction, and the lateral acceleration which is generated when traveling at the curve limitation travelling speed becomes within a range from the bound lateral acceleration at the longitudinal acceleration in the back direction to the maximum lateral acceleration, the travelling speed corrector corrects the curve limitation travelling speed so that the longitudinal acceleration becomes 0.

7. The vehicle control apparatus according to claim 1,
wherein the lateral movement parameter setter sets a maximum acceleration lateral acceleration, at the longitudinal acceleration in the front direction, which is smaller than the maximum lateral acceleration,
wherein, when the longitudinal acceleration which is generated when traveling at the curve limitation travelling speed becomes a value of the front direction, and the lateral acceleration which is generated when traveling at the curve limitation travelling speed becomes the maximum acceleration lateral acceleration at the longitudinal acceleration in the front direction or less, the travelling speed corrector corrects the curve limitation travelling speed so that the longitudinal acceleration becomes the maximum longitudinal acceleration in the front direction.

8. The vehicle control apparatus according to claim 1,
wherein the lateral movement parameter setter sets a maximum deceleration lateral acceleration, at the longitudinal acceleration in the back direction, which is smaller than the maximum lateral acceleration,
wherein, when the longitudinal acceleration which is generated when traveling at the curve limitation travelling speed becomes a value of the back direction, and the lateral acceleration which is generated when traveling at the curve limitation travelling speed becomes the maximum deceleration lateral acceleration at the longitudinal acceleration in the back direction or less, the travelling speed corrector corrects the curve limitation travelling speed so that the longitudinal acceleration becomes the maximum longitudinal acceleration in the back direction.

9. The vehicle control apparatus according to claim 1,
wherein, in an acceleration section of the curve limitation travelling speed, and a constant speed section in front of the acceleration section, the travelling speed corrector calculates the curve limitation travelling speed after correction in order toward front so that the composite acceleration becomes within the limit range;
in a deceleration section of the curve limitation travelling speed, and the constant speed section in back of the deceleration section, the travelling speed corrector calculates the curve limitation travelling speed after correction in order toward back so that the composite acceleration becomes within the limit range;
in a case where the constant speed section of the curve limitation travelling speed is the constant speed section in front of the acceleration section and is the constant speed section in back of the deceleration section, the travelling speed corrector calculates either smaller one of the curve limitation travelling speed after correction calculated in order toward front, and the curve limitation travelling speed after correction calculated in order toward back, as the final curve limitation travelling speed after correction; and
in a case where the constant speed section of the curve limitation travelling speed is not the constant speed section in front of the acceleration section and is not the constant speed section in back of the deceleration section, the travelling speed corrector calculates the curve limitation travelling speed, as the curve limitation travelling speed after correction.
